(19) United States
(12) Patent Application Publication
(10) Pub. No.: US 2004/0162768 A1
(43) Pub. Date: Aug. 19, 2004

(54) System architecture for a vendor management inventory solution

(76) Inventors: Aaron Francis Snyder, Walhalla, SC (US); Michael Donnelly, Powhatan, VA (US); Paul Stephen Brackett, Apex, NC (US); Gerald Thomas Lee, Raleigh, NC (US); Karen Jane Smiley, Benson, NC (US); Ahmet Yigit, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/722,259

(22) Filed: Nov. 25, 2003

Related U.S. Application Data
(60) Provisional application No. 60/444,111, filed on Jan. 31, 2003.

(51) Int. Cl. G06F 17/60

(52) U.S. Cl. 705/28; 705/8

(57) ABSTRACT

Systems and methods for vendor managed inventory (VMI) that include a demand management system that receives customer product usage data and forecasts customer demand for products in accordance with the product usage data. The VMI system also includes an order management system that receives orders from the demand management system and sends the order for fulfillment. A relational database stores customer information for later retrieval and ad hoc querying. An aspect integrator platform is provided for collaboratively presenting the customer information.

### CROSS-REFERENCE TO RELATED APPLICATIONS

This application claims the benefit of U.S. Provisional Application No.

filed Jan. 31, 2003, which is incorporated herein by reference in its entirety.

### FIELD OF THE INVENTION

The present invention is related to inventory management systems. More particularly, the invention relates to a system and method of processing customer usage information for demand forecasting on a per-product basis.

### BACKGROUND OF THE INVENTION

Utilities are under pressure to maintain and/or improve their readiness to serve, however, most have poorly coordinated planning processes. The utilities face problems of cyclic demand for distribution products and massive pressure to reduce inventory to levels consistent with other major industries. The utilities as an industry are unique in that the levels of service they are expected to supply are extreme. Critical services, response time and availability have been historically fulfilled by ensuring inventory and service resources are available close to point of consumption. The broad service area and variety of management challenges (e.g., weather, load fluctuations, and nature of residential and commercial construction) have made predicting equipment needs extremely difficult for utilities. Inventory has been the traditional tool to address these challenges, but with restructuring, deregulation and pressure from the capital markets to improve returns, historic inventory levels will be unacceptable in the future.

Another problem is that utilities have typically relied upon loosely coordinated, manual forecasting of future growth and needs. Historically, demographic, load, and weather projections have not been combined into an overall need assessment, and the tools used in performing even these forecasts have not kept pace with state-of-the-art development in other industries.

Another need is one of integration. The integration of the different tools within the supply chain to provide a more comprehensive picture of supply and demand will place both suppliers and purchasers in a better position for making effective decisions. Effective integration with key suppliers will also enable real-time and intelligent trade-offs in the manufacturing scheduling process. Savings realized by vendors in using a forward-looking order management solution that is integrated into customer planning and forecasting will assist in level loading at factories, reducing scrap, reducing change-over costs, reducing overtime labor costs and improving financial forecasts.

By better understanding the unique equipment needs of a customer, where and when these needs are likely to materialize, and what information end-user installers need to drive total cost out of the supply chain and maximize useful life, a vendor will be in an optimum position to deliver additional asset management solutions to key customers. The present invention addresses the above needs and provides a solution for both customers and vendors.

### SUMMARY OF THE INVENTION

The present invention is directed to aspects and features of customer and vendor inventory management. In accordance with one aspect of the invention, there is provided an automated order management system. The system includes a vendor management inventory (VMI) server that includes a demand management system that receives customer data indicative of inventory, a relational database for storing the customer data, and an aspect integrator that provides an integrated graphical user interface to the VMI server. The aspect integrator provides multiple views of the customer data in accordance with user credentials. The customer data may be input from an enterprise resource planning system on a periodic basis to the VMI server.

According to a feature of the invention, the demand management system selects a forecasting method and creates a forecast. The demand management system then decides if an order for additional units of a product to be supplied to a customer is necessary in accordance with the forecast. The demand management system may then send an order to an order management system that may parses the order and sends it to supplier factories for fulfillment.

According to another feature, the relational database stores at least one of SKU, quantity issued, quantity on hand, date, and warehouse location for each customer.

The demand management system of the present invention may include an inventory control and optimization component, a demand forecasting component, a distribution planning component, and an order replenishment component. The inventory control and optimization component may create a knowledge base for future forecasts in accordance with past demand and external parameters related to a product being forecasted. Forecasting may be performed on a per customer, per product basis and wherein forecasting may be based on at least one of the following models: time series analysis with moving averages, regression analysis, and lifecycle models.

According to another feature of the invention, the demand forecasting component collects customer-level input and makes forecast changes visible in a collaborative environment. It also may report of at least one of actual and required inventory levels, actual and required inventory usage, units or dollars, forecasted customer demand, and forecasted industry demand for plant loading.

The distribution planning component may provide multiple views for supply chain planning. The views may include a statistical view for applying mathematical models, a marketing view that is product family and region focused, a sales view that is customer focused, and a manufacturing view that is used for resource management.

In accordance with yet another feature, the order replenishment component may replenish stock levels using forecast results, on hand inventory, WIP inventory, and in transit inventory.

According to another aspect of the invention, a method of forecasting demand in a vender managed inventory environment is provided. The method includes receiving customer inventory usage data; forecasting products for a customer based on the usage data; generating forecast reports; inputting the forecast reports to a replenishment system; determining new orders based on the usage data and the forecast reports; and forwarding the new orders to an order entry system for fulfillment.

According to a feature of the invention, the forecast reports include a revised forecast, marketing reports, forecast history reports and a demand update report.

The method may also include updating inventory by calculating optimized inventory levels on a per customer, per location, and per product basis. Additionally, the method may include replenishing customer stock levels using forecast results, on hand inventory, and unshipped orders.

According to another aspect of the invention, there is provided a system for vendor managed inventory. The system includes a demand management system that receives customer product usage data and forecasts customer demand for products in accordance with the product usage data, an order management system that receives orders from the demand management system and parses sends the order for fulfillment, a relational database system for storing customer information, and an aspect integrator platform for collaboratively presenting the customer information.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an overview block diagram showing a vendor managed inventory (VMI) system in accordance with the present invention;

FIG. 2 is a block diagram illustrating a demand management system in accordance with the, present invention;

FIGS. 3-4 are flowcharts illustrating the processes performed by the demand management system;

FIG. 5 illustrates exemplary use cases within the VMI system;

FIG. 6 is a exemplary database view of the present invention;

FIG. 7 is an exemplary supply management process;

FIG. 8 is an alternative supply management process;

FIG. 9 is an overlay of the processes of FIGS. 7 and 8 which forms a generic process i n accordance with the present invention;

FIGS. 10-12 are exemplary user interfaces in accordance with the present invention.

### DETAILED DESCRIPTION OF ILLUSTRATIVE EMBODIMENTS

The present invention provides systems and methods for forecasting demand for products based on historical data and converts the data into orders for products. The present invention seeks to improve upon the supply chain process to provide significan t savings to customers and suppliers. In particular, the present invention will allow customers to reduce inventory-carrying costs by better tracking inventory and more accurately forecasting future needs.

The present invention couples customer planning, analysis and forecasting tools with an advanced forecasting capability, tightly integrated with inventory management and supplier scheduling tools. The advanced forecasting tool will allow the customer to calculate more precisely future demand for equipment purchase and to test different scenarios for optimizing the planning-ordering-consumption cycle.

By linking existing end-user (i.e., customer) practices to their supplier's (i.e., vendor's) manufacturing systems, a vendor will be in a position to manage their customer's supply of their products based on automatic pre-determined trigger points, historic use patterns, future projected plant loading, and other factors such as weather. Manual entry of required equipment (product ordering) will continue to be possible.

In this manner, the customer and vendor jointly manage the customer inventory. This relationship is referred to herein as “vendor managed inventory” (VMI). The VMI process operates on a continual basis, contributing to the overall effectiveness of the customer's organization.

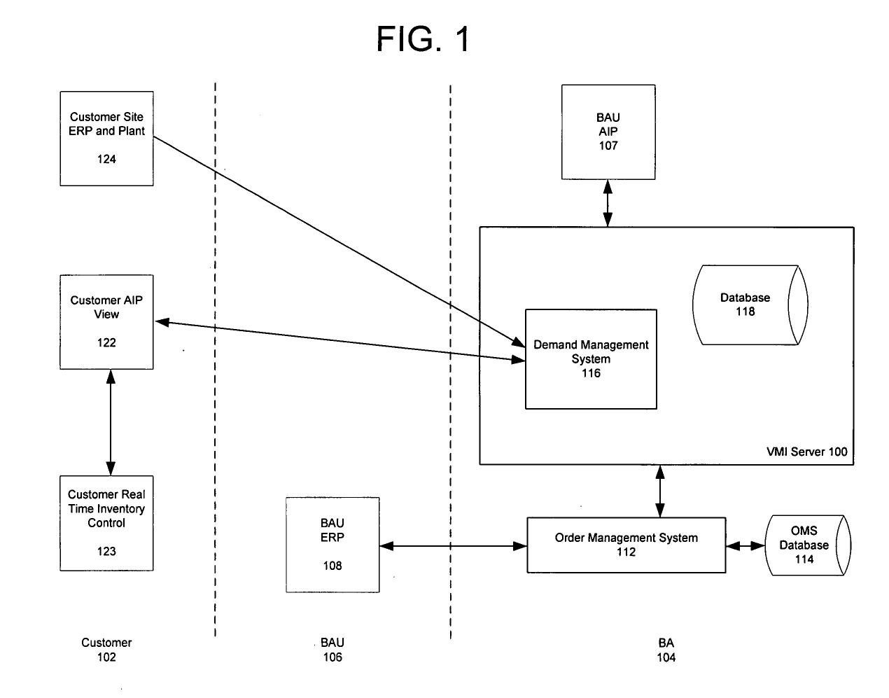

Referring now to FIG. 1, there is an overview of the present invention. Customers 102, through their Enterprise Resource Planning (ERP) systems 124 attempt to integrate all departments and functions across a company onto a single computer system that can serve all those different department's particular needs. Inventory at the customer site 102 is monitored by the central customer stock system (ERP) 124 that communicates a particular utility's inventory status into to a demand management system 116, running on a VMI server 100, located at a Business Area (BA) 104. A BA 104 is a group of Business Area Units (BAUs) 106, which each may be a particular manufacturing facility or business.

Users interact with the system by logging on to Aspect Integrator Platforms (AIP) 122 and 107, either locally, or remotely using a WWW interface via the Internet. The AIPs 107 and 122 provide an integrated graphical user interface to the VMI server 100.Specific workplaces will provide the different users with convenient and intuitive access to all relevant information. VMI related real-time control systems (such as a warehouse control system) may also be presented in the AIP. In addition, the customer AIP 122 may feed a real-time inventory control system 123 to provide the customer 102 with real-time inventory information that may be made visible on customer-specific systems.

Customer inventory activity data (usage data) may be automatically input from their ERP system via multiple formats on a daily (or some other periodic) basis. The customer usage data may be contained in either flat files, i.e., plain text, extensible markup language (XML), or comma separated variable (CSV), or EDI transactions (EDI 852) that are transmitted via electronic means and translated into a proper format for the demand management system 116 within the BA 104. Inputs may also be made manually either from customer supplied data or from plant (BAU 106) Enterprise Resource Planning (ERP) system 108.

The demand management system 116 automatically selects a forecasting method and creates a forecast. The forecast can then be accepted or overridden by the customer or a supplier representative. Once the forecast is accepted, any inventory adjustment will be compared with orders in process and orders in transit. The demand management system then decides if an order for additional units is necessary. Once again, the pending order may be accepted or overridden by the customer or a supplier representative.

After the order is approved by the customer, the demand management system 116 sends an order to an order management system 112 via, e.g., an XML or EDI 852 message. Other formats for transmitting the order may be used in accordance with the present invention. The order management system 112 then parses the order and sends it to the appropriate supplier factories for fulfillment.

It is preferable that the demand management system 116 and a relational database 118 store customer data for a three year period of time. The database 118 is preferably SQL server, available from Microsoft Corporation. The demand management system 116 may query the database 118 to conduct basic ad hoc analysis such as viewing past actual against current forecasts. The demand management system 116 provides a mechanism to refined and improve future forecasts. The demand management system 116 provides a software interface e.g., an API, that supports a link with other system databases such as Manufacturing Resource Planning (MRP) or an order management database 114. The database 114 is preferably SQL server, available from Microsoft Corporation. The demand management system 116 preferably offers an open architecture and object oriented architecture such that it has the capability to combine multiple off-the-shelf software applications. For example, the demand management system 116 provides a system to easily combine a systems forecast engine with an Excel spreadsheet to create an integrated solution.

As noted above, the demand management system 116 has the capability to accept customer inventory activity data presented in EDI 852, TXT, XLS, and XML formats. The customer inventory data may arrive on a daily basis and is stored in a database 118. The data may be received on a lesser periodic basis, however, inventory accuracy will not be as accurate. The following five fields are preferably utilized for periodic data: SKU, Quantity issued, Quantity on hand, Date, and Warehouse location.

The information contained within EDI 852 transactions may be separated into two major concentrations: current inventory status information provided to the supplier for product replenishment purposes, and sales movement information provided to the supplier for use in the supplier's product planning process. Due to the very specific nature of VMI relationships, each of the fields noted above contained within this transaction are defined and understood by both the customer and the supplier. As such, data transmitted in XML, TXT, and XLS preferably contain the same five fields used in the EDI 852 format will be required.

To initially set up a customer in the VMI system 100, it is preferable to input a demand history (e.g., 3 years), established safety stock if used in place of service levels, and exceptions to forecasted quantities. The safety stock and exceptions may be updated on a continuous basis.

The interface from the demand management system 116 to the order management system 112, includes two software components. The first converts the RPR output from the demand management system 116 to XML, and the second converts the XML to the OMS format used by the order management system 112. The order management system 112 is a customer relationship management system. The RPR to XML component may include one of several options to create the XML file. These include a web based front end, a standalone VisualBasic application, a standalone application written with some other language, and exporting the file as a “flat file.” It is preferable, however, to write the XML file utilizing a Microsoft XLS “macro” as this reduces the amount of knowledge required by end users and supporting infrastructure. The result of running the XLS macro is a file containing the XML data required for order input. This file or files may be attached to an e-mail and sent to the field service representative who will review and load it into the order management system 112. The XML to OMS format component includes a screen that a field service representative may use to locate, review, and download the information into the system 100. A forecast may be manually revised using these software components.

In addition to the above, it is preferable that the technology individual components are reusable. Further, the VMI system 100 should be operational “≧×7,” except for planned upgrades of new software versions or on-site validation tasks.

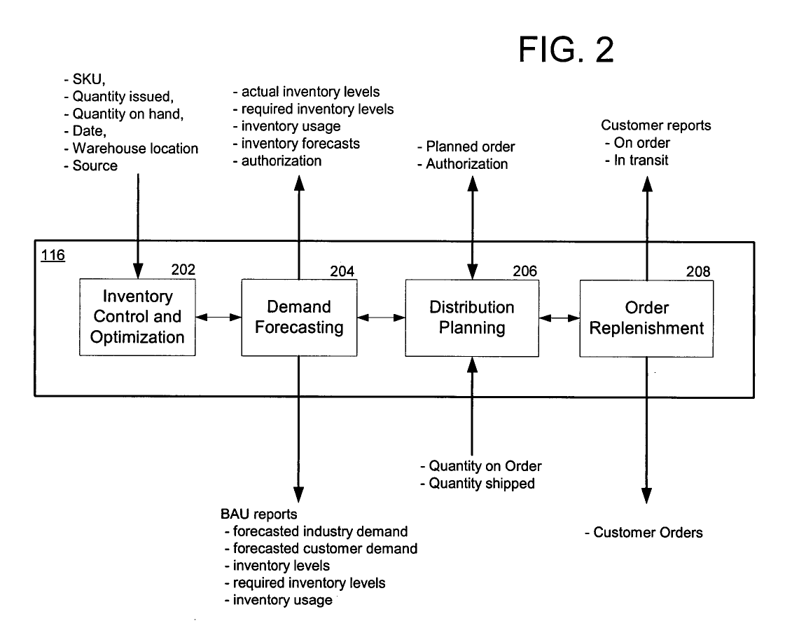

Referring to FIG. 2, the demand management system 116 of the present invention will now be described in greater detail. The demand management system 116 preferably provides four functions: Inventory Control and Optimization 202, demand forecasting 204, distribution planning 206, and order replenishment 208.

The Inventory Control and Optimization 202 component is a collection of inventory control and optimization algorithms based on past demand (initially actual or order), and external parameters such as life cycle and weather conditions. It creates a knowledge base by which future forecasts can be refined and improved. Customer data is collected from agents and marketplaces.

Demand forecasting is preferably performed on a per customer, per product basis. As noted above, demand forecasting may utilize one or more models. The following models are a representative set of model utilized by the present invention: time series analysis with moving averages (e.g., simple, exponential, box-Jenkins, Fourier), regression analysis (e.g., Multivariable), and lifecycle models. Customers and plants are able to override or adjust the forecast for known events that will effect inventory requirements. A comment field may be included so the reason for the override can be stated. Customers and plants may fine-tune the forecasts so that the quality of the forecasts can be improved over time. A comment field may be included so the reason for the fine-tuning can be stated. The Demand Forecasting component 204 prepares forecasts at product group aggregate, warehouse, and SKU levels. For example, short-term forecasts may be a 3 month time frame (e.g., a 3 month rolling forecast). Support for time aggregation includes the ability to do the aggregated forecast or input from one set of time buckets to another.

The Demand Forecasting component 204 enables collaborative forecasting, which is the process for collecting and reconciling the information from diverse sources inside and outside the vendor company, to come up with a single unified statement of demand. It consists of five aspects. The first is processes and systems to collect customer-level input routinely. In some businesses, this may be referred to as geographic information. The second is input to forecast collection process is preferably distributed one, and allows each sales person to operate independently without being connected directly to the forecasting system. The third is to support visibility of forecast changes in a collaborative forecasting environment, multiple organizations provides input that is consolidated into the final statement of demand. The fourth is that the forecasting system maintains the changes made at each organizational level. The fifth aspect processes to merge management overrides and inputs with the data collected at the customer level.

The Demand Forecasting component 204 additionally provides ad hoc reporting capabilities, such as actual and required inventory levels (units or dollars), actual and required inventory usage, units or dollars, forecasted customer demand (units or dollars), and forecasted industry demand for plant loading (units).

The Distribution Planning component 206 supports managing multiple views for collaboration with a well-defined methodology for converting a forecast from one view to another. There are multiple views that preferably support supply chain planning. A first view is a statistical view for applying mathematical models. This view is at a level of aggregation where the statistical models provide useful results. A second view is a marketing view that is product family and region focused. This view is used to input aggregate changes for existing products, new products, handle product substitution, and check for critical components. A third view is a sales view, which is customer focused. It is used to gather customer-related information. An example of this view would be a view by region, sales office, and customer. A fourth view is a manufacturing view that is used for resource management. This would typically be by product or product family, and by week or month. It is preferably that customers and plants are able to override orders before they are sent to the OMS system 112.

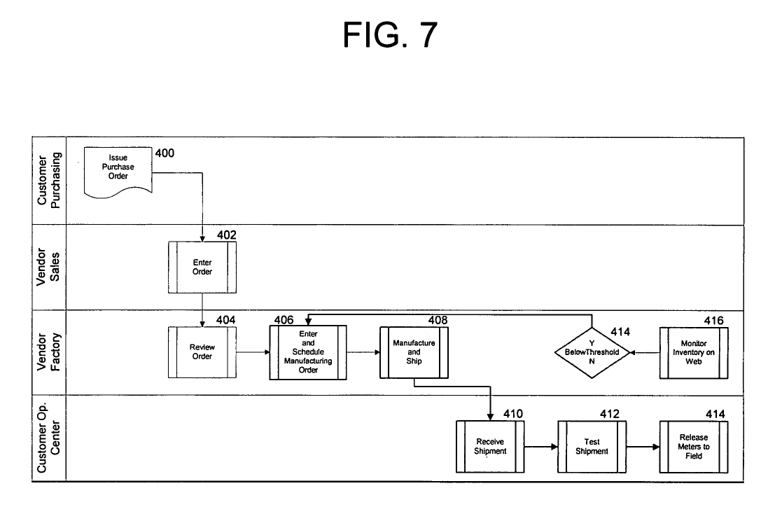

The Order Replenishment component 208 is provided to replenish stock levels using forecast results, on-hand inventory, work in progress (WIP) inventory, and in transit inventory. This capability of Demand Management 116 will streamline the front and back end functionality for ensuring that Products/Services ordered through the present invention are fulfilled quickly and efficiently through the sourcing location. The Demand Forecasting component 204 provides reports showing order tracking and order history. The potential to streamline back-office operations by minimizing or eliminating non-value added process steps will be further detailed with regard to FIGS. 7-9 using best practice supply chain management capabilities.

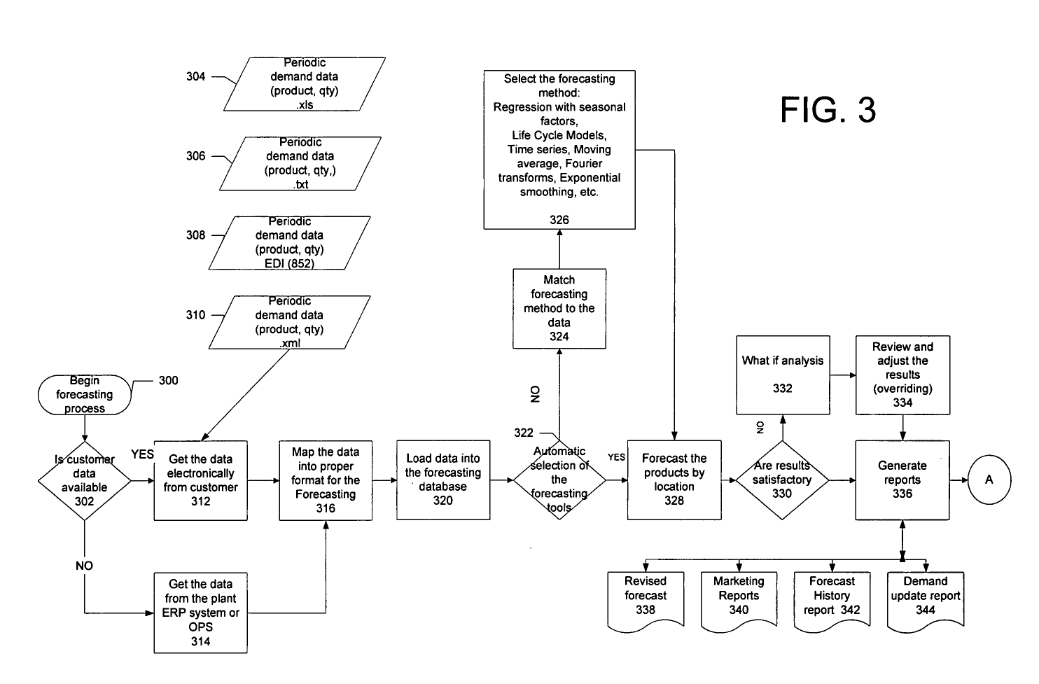

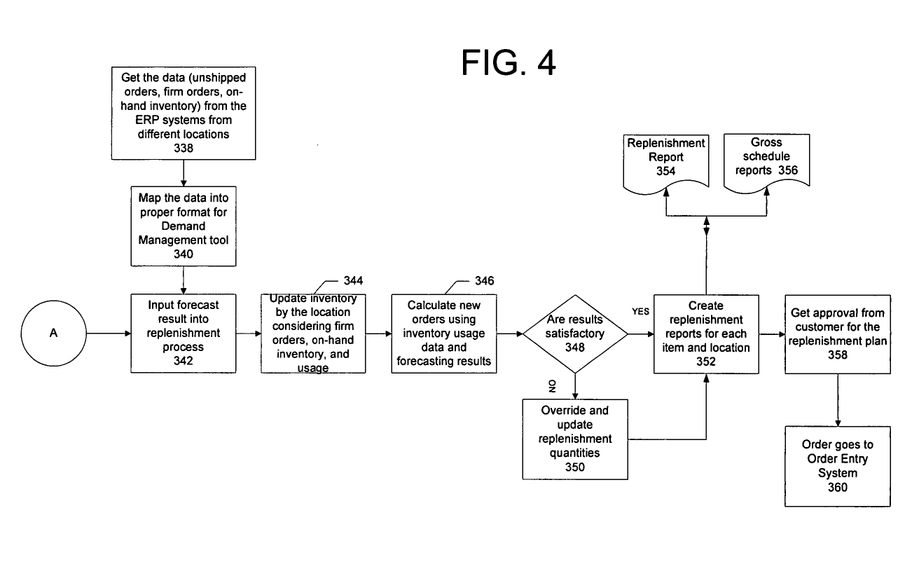

FIGS. 3 and 4 show the process used for Demand Management, and in particular the Inventory Control 202 and Demand Forecasting 204 components (FIG. 3) and the Distribution Planning and Order Replenishment components (FIG. 4).

Referring to FIG. 3, there is illustrated the process for demand forecasting in accordance with the present invention. The forecasting process begins at step 300. It is then determined if the customer data is available at step 302. If not, at step 314 the data is retrieved from the appropriate source (e.g., an ERP system or operations system). If the data is available, then it is retrieved from the customer at step 312. The data retrieved may include data in XLS, TXT, EDI 852 or XML formats 304, 306, 308 or 310. Once data is received at either of steps 312 or 314, the data is mapped into the proper format for forecasting at step 316, then loaded into the forecasting database 118 at step 320.

At step 322, the forecasting tools of the demand management system 116 are selected. If there is not an automatic selection, then the forecast method is matched to the data at steps 324 and 326. At step 328, the forecast for products by location is generated and it is determined if the results are satisfactory at step 330. If the results are not satisfactory, then a “what if” analysis is performed at step 332. The results are then adjusted (i.e., overridden) at step 334. If the results are satisfactory at step 330, then the reports are generated, as well as when the results of the “what if” analysis are satisfactory. The reports may include, but are not limited to, a revised forecast 338, marketing reports 340, forecast history reports 342 and a demand update report 344. The processing then branches to FIG. 4, as described below.

Inventory control is performed by accepting customer inventory activity data presented in an EDI 852, XML, XLS, and TXT formats. Customer input can arrive on a daily basis or less often.

Inventory optimization is performed by calculating optimized inventory levels on a per customer, per location, and per product basis. The inventory optimization algorithms are preferably based on past demand, and/or external parameters, such as life cycle and weather conditions. A knowledge base may be created by which future forecasts can be refined and improved.

The demand management system 116 replenishes customer stock levels using forecast results, on hand inventory, and unshipped orders. The capability of demand management system 116 are streamlined to ensure that products and/or services ordered through VMI system 100 are fulfilled quickly and efficiently through the sourcing location. Additionally, transaction processing between customers and suppliers are automated as much as possible.

FIG. 4 shows the process used for distribution planning and order replenishment. Data is retrieved from ERP systems and mapped into proper format for the demand management system 116 at steps 338 and 340 if forecasts are generated manually. The manually generated forecasts and the forecasts generated by the demand forecasting tool in accordance with the process of FIG. 3 are input into the replenishment process at step 342. Next, at step 3444, inventory is updated and new orders are calculated at step 346. The results are checked at step 348. If the results are not satisfactory, then at step 350, they may be manually overridden. If the results are acceptable, either as calculated or manually updated, replenishment reports are generated at step 352. The reports may include, but are not limited to, a replenishment report 354 or gross schedule report 356. At step 358, customer approval for the replenishment plan is obtained and the order is then placed (step 360) into the order management system 112.

Customers may desire to confirm orders placed by the demand management system 116. As noted above with regard to FIG. 3, sales agents may perform a “what if analysis.” After forecasting, the user should able to manipulate the results of a forecast by changing the method, time frame, exceptional events, etc. Sales agents may also calculate on-hand inventory. The system should calculate on hand inventory given warehouse usage. The sales agents may create replenishment plan. This represents the ability to create a replenishment plan for customer approval. Finally, the sales agents may desire to display shipping options.

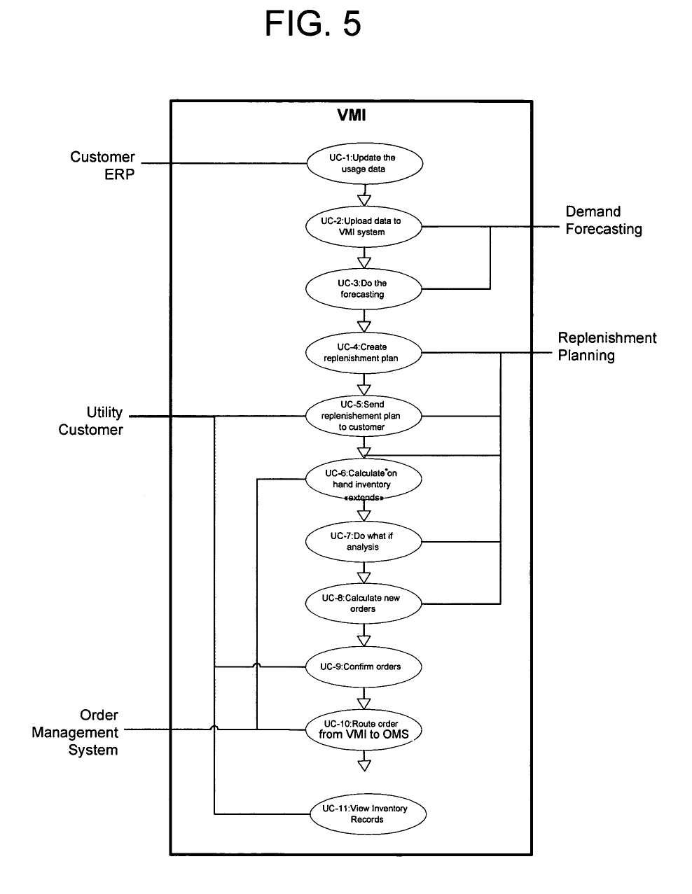

Referring now to FIG. 5, there is illustrated the various use cases associated with the present invention. Table 1 below summarizes the use cases:

TABLE 1

| Use Case | | User/Actor | |
|---|---|---|---|
| No. | Name | (See, FIGS. 1-2) | Brief Description |
| UC-1 | Update the | Customer ERP | After customer accesses the VMI system, he/she sends |
| | usage data | | the usage data to the BA. |
| UC-2 | Uploading | Forecasting | This is the ability to get the data into the VMI system. |
| | data to the | | The system needs updated data when a customer is |
| | VMI system | | initially added and when product requirements change. |
| UC-3 | Do the | Forecasting | Users are able to forecast given the usage data. |
| | forecasting | | |
| UC-4 | Create | Replenishment | The ability to create replenishment plan that will send to |
| | replenishment | | the customer for approval. |
| | plan | | |
| UC-5 | Send | Replenishment, Utility | The ability for a customer to receive the replenishment |
| | replenishment | Customer | plan that the VMI system generates. |
| | plan to the | | |
| | customer | | |
| UC-6 | Calculate on | Replenishment, OMS | The VMI system should calculate on hand inventory |
| | hand inventory | | given warehouse usage. |
| UC-7 | Perform “what | Replenishment | After forecasting the user is able to experiment with the |
| | if analysis” | | result of forecast by changing the method, time frame, |
| | | | exceptional events, etc. |
| UC-8 | Calculate new | Replenishment | Calculating the order quantities considering on hand |
| | orders | | inventory, firm orders, in-transit orders, etc. |
| UC-9 | Confirm an | Utility Customer | The customer has received the order and approved it. |
| | order | | |
| UC-10 | Route order to | VMI system, OMS | The action of taking a customer's order by line item and |
| | OMS | | transferring into the Order Management system. |
| UC-11 | View | Utility Customer | The customer is able to view inventory on hand, and parts |
| | Inventory | | on order records. |
| | Records | | |

Table 2 below outlines the various business events that may occur within the VMI server 100.For example, customers may update usage data. After a customer uses a product, the customer sends the usage data to the supplier plant. Also, sales agents may upload data to the VMI system 100. This represents the ability to get the data into the VMI system. The system 100 uploads and maps the data as appropriate. Sales agents may also perform forecasting. This is the primary function of the VMI system 100. Users should able to provide forecasts given the usage data. The sales agents may also calculate new orders by considering on-hand inventory, firm inventory, shipped items, etc.

TABLE 2

| | | Output to other | Related internal |
|---|---|---|---|
| Business Event Name | Input from other systems | systems | objects or entities |
| Load historical customer data | Customer ERP, BAU ERP | Demand Forecasting | |
| Load customer inventory usage | Customer ERP, BAU ERP | Demand Forecasting | |
| data | | | |
| Map data into proper format | | | Demand Forecasting |
| Select forecast method | | | Demand Forecasting |
| Forecast product needs by | | | Demand Forecasting |
| customer location | | | |
| Review product forecasts | Customer | Demand Forecasting | |
| Generate forecast reports | Demand Forecasting | Customer | |
| Load customer “on-order” data | BAU ERP | Replenishment | |
| Update inventory on-hand | Customer ERP, | | Replenishment |
| records | BAU ERP | | |
| Calculate replenishment | | | Replenishment |
| requirements | | | |
| Review customer order | Customer | Replenishment | |
| requirements | | | |
| Get customer approval for orders | Customer | Replenishment | Replenishment |
| Send order to Order | Replenishment | Order Management | |
| Management System | | System | |
| Generate Order Reports | Replenishment | Customer | |

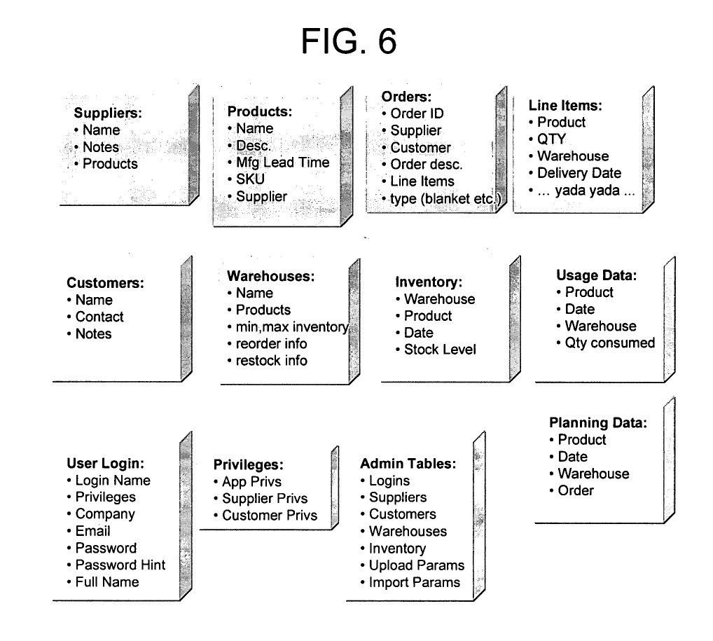

Referring now to FIG. 6, there is illustrated an exemplary view of the database tables that comprise databases 114 and 118 of FIG. 1. The database view illustrates nine tables that store supplier information, product information, orders, line items, customer data, warehouse information, inventory, usage data and planning data. Three additional table serve administrative functions, such as user data, privileges and administrative tables. It is noted that this design of the databases 114 and 118 is not limited to that of FIG. 6.

Referring now to FIG. 7, there is illustrated the supply management process of the present invention. There are four major stakeholders: customer purchasing, customer operations center, vendor sales, and a vendor factory. There are ten discrete points in the process, which is advantageously fewer than the conventional supply management process. The bolded lines represent recurring processes within the flow of FIG. 7.

Initially, customer purchasing issues a purchase order (step 400), which is entered at step 402 by vendor sales. The vendor factory reviews the order at step 404, then enters and schedules the manufacturing order at step 406. Next, at step 408, the factory manufactures and ships the products ordered at step 400. At step 410, the customer operations center receives the shipment and tests the shipment at step 412. In the exemplary flow of FIG. 7, the product ordered at step 400 are electric meters, which are released to the field at step 414 after the completion of testing.

At step 416, the present invention monitors customer inventory and determines if it is below a threshold at step 418. If so, the present invention enters and schedules the manufacturing order at step 406 to maintain the customer at an inventory that will meet future expected needs.

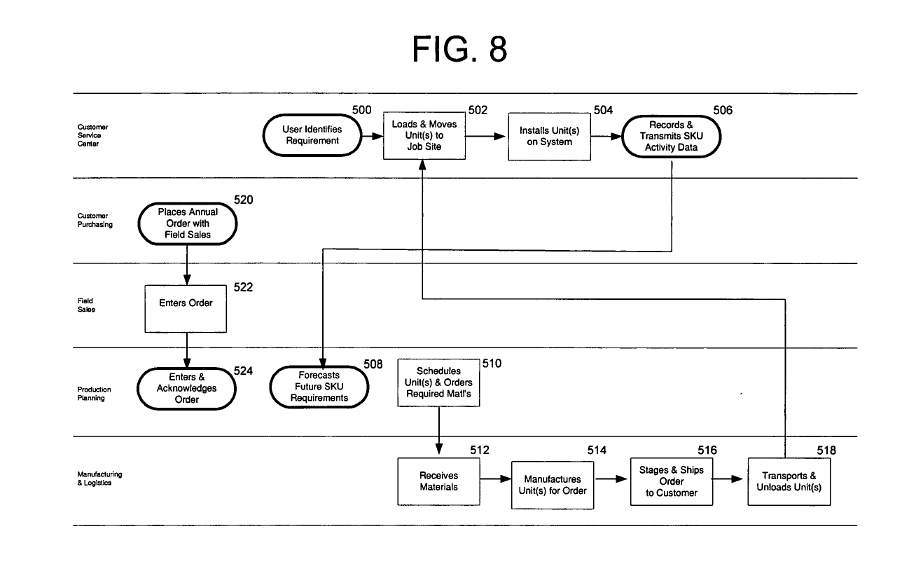

Referring to FIG. 8, there is illustrated another supply management process in accordance with the present invention. There are five stakeholders: customer purchasing, customer service center, customer inventory control, vendor sales, vendor production planning, vendor manufacturing & logistics and vendor finance. There are fifteen discrete points in the process.

Beginning at step 500, a user at a customer service center identifies a requirement an moves a unit to a job site at step 502. The unit is installed at step 504 and the SKU activity data is recorded and transmitted (step 506) to a vendor's production planning for forecasting requirements at step 508. Production planning schedules units and orders required materials at step 510 based on forecasts, etc. At step 512, the vendor's manufacturing and logistics receives the materials (step 512) and manufactures the units for order at step 514. The orders are staged and shipped at step 516 and transported at step 518, where the manufactured units may be loaded and moved to the customer job site step 502.

Separately, customer purchasing may place an annual order with the vendor's field sales at step 520. The field sales personnel ender the order at step 522 and the vendor's production planning acknowledges the order at step 524.

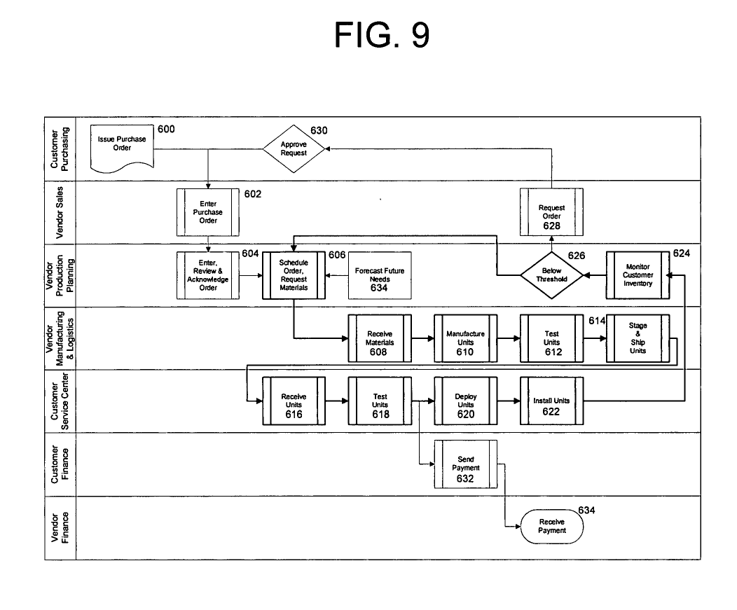

Referring now to FIG. 9, there is illustrated an overlay of the processes of FIGS. 7 and 8, which forms a generic process. The recurring processes are shown in bolded lines. The number of stakeholders is seven: three from the customer and four from the vendor. The number of discrete points is nineteen.

The flow of the generic process begins at step 600 where the customer purchasing agent issues a purchase order. At step 602 the he vendor sales agent enters the purchase order and passes the order to the plant. At step 604 he vendor plant production planning section enters, reviews and acknowledges the order. The order is scheduled and materials for completing the order are requested at step 606. Independently, the future materials needs are forecasted for the products (step 634)

Next, at steps 608-614, the vendor manufacturing and logistics section receives the materials, manufactures, tests, and stages and ships the products. At steps 616-622, the customer service/operations center receives, tests, deploys and installs the products. An acceptance notice is sent to the customer finance department after testing at step 618. The customer finance department sends payment to the vendor finance department at step 632 and the vendor finance department receives the payment at step 634.

Another improvement of the process is sending information about the product installation to an inventory monitor at the vendor production and planning section. If the quantity on hand of the product at the customer site is below a pre-determined and agreed-upon threshold, either the vendor starts the manufacturing process to send more product to the customer, or a message that to request an order is sent to the vendor sales agent. The vendor sales agent then asks the customer purchasing agent for approval.

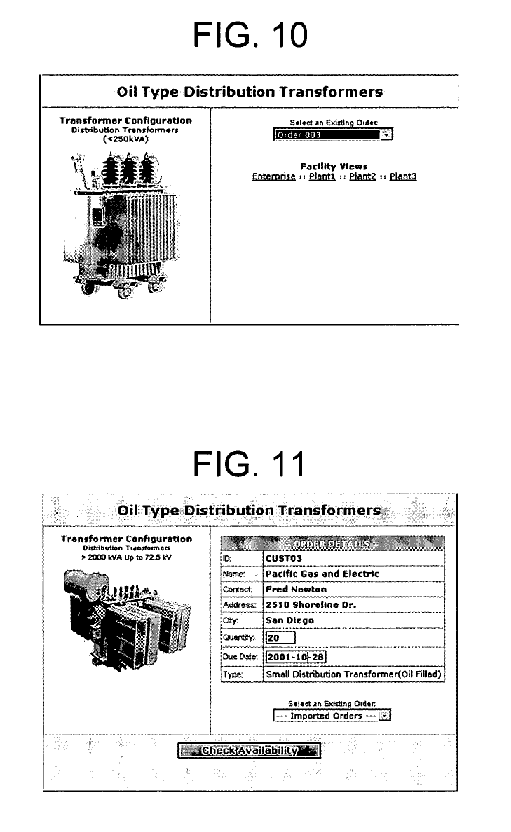

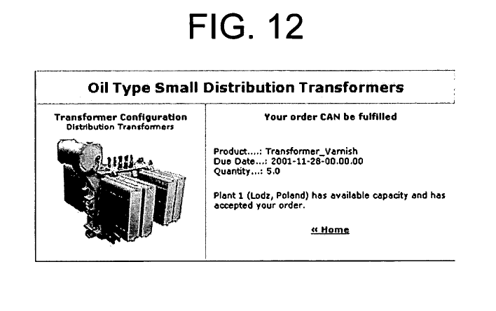

FIGS. 10-12 illustrate exemplary customer user interfaces by which customers may access the information system of the present invention. In FIGS. 10-12, the customer desire to purchase an oil type transformer and enters the order details. The customer may check availability and the system will return an acceptance from a plant (BAU) that has the capacity and materials to fulfill the order within the requested time period.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

A representative hardware configuration for the VMI system 100 is an Intel Pentium III 733 MHz or faster, 5 GB hard disk storage, 24X CD-ROM drive, 100 Mbps Ethernet, 1280×1024 resolution at 16 million colors (24 bit), a 20″ screen, Sound Blaster 16-bit compatible sound card, and 512 MB RAM.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, may be applied to a serialization format other than XML, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed:

1. An automated order management system, comprising:
a vendor management inventory (VMI) server comprising a demand management system that receives customer data indicative of inventory;
a relational database for storing said customer data; and
an aspect integrator that provides an integrated graphical user interface to the VMI server, said aspect integrator providing multiple views of said customer data in accordance with user credentials.

2. The system of claim 1, wherein said customer data is input from an enterprise resource planning system on a periodic basis to said VMI server.

3. The system of claim 1, wherein said demand management system selects a forecasting method and creates a forecast, and wherein said demand management system decides if an order for additional units of a product to be supplied to a customer is necessary in accordance with said forecast.

4. The system of claim 3, wherein the demand management system sends an order to an order management system, wherein said order management system parses the order and sends the parsed order to supplier factories for fulfillment.

5. The system of claim 3, wherein said relational database stores at least one of SKU, quantity issued, quantity on hand, date, and warehouse location for each customer.

6. The system of claim 1, wherein said demand management system includes an inventory control and optimization component, a demand forecasting component, a distribution planning component, and an order replenishment component.

7. The system of claim 6, wherein said inventory control and optimization component creates a knowledge base for future forecasts in accordance with past demand and external parameters related to a product being forecasted.

8. The system of claim 7, wherein forecasting is performed on a per customer, per product basis and wherein forecasting may be based on at least one of the following models: time series analysis with moving averages, regression analysis, and lifecycle models.

9. The system of claim 6, wherein said demand forecasting component collects customer-level input and makes forecast changes visible in a collaborative environment.

10. The system of claim 9, wherein said demand forecasting component provides reporting of at least one of actual and required inventory levels, actual and required inventory usage, units or dollars, forecasted customer demand, and forecasted industry demand for plant loading.

11. The system of claim 6, wherein said distribution planning component provides multiple views for supply chain planning, wherein said multiple views comprise a statistical view for applying mathematical models, a marketing view that is product family and region focused, a sales view that is customer focused, and a manufacturing view that is used for resource management.

12. The system of claim 6, wherein said order replenishment component replenishes stock levels using forecast results, on hand inventory, WIP inventory, and in transit inventory.

13. A method of demand forecasting in a vender managed inventory environment, comprising
receiving customer inventory usage data;
forecasting products for a customer based on the usage data;
generating forecast reports;
inputting said forecast reports to a replenishment system;
determining new orders based on said usage data and said forecast reports; and
forwarding said new orders to an order entry system for fulfillment.

14. The method of claim 13, wherein the forecast reports include a revised forecast, marketing reports, forecast history reports and a demand update report.

15. The method of claim 13, further comprising updating inventory by calculating optimized inventory levels on a per customer, per location, and per product basis.

16. The method of claim 15, further comprising replenishing customer stock levels using forecast results, on hand inventory, and unshipped orders.

17. A system for vendor managed inventory, comprising:
a demand management system that receives customer product usage data and forecasts customer demand for products in accordance with said product usage data;
an order management system that receives orders from said demand management system and parses sends the order for fulfillment;
a relational database system for storing customer information; and
an aspect integrator platform for collaboratively presenting said customer information.

18. The system of claim 17, wherein said demand management system decides if an order for additional units of products to be supplied to a customer is necessary in accordance with said forecasts.

19. The system of claim 17, wherein said customer information stored in said relational comprises at least one of SKU, quantity issued, quantity on hand, date, and warehouse location.

20. The system of claim 17, wherein said demand management system includes an inventory control and optimization component, a demand forecasting component, a distribution planning component, and an order replenishment component.

21. The system of claim 20, wherein said inventory control and optimization component creates a knowledge base for future forecasts in accordance with past demand and external parameters related to a product being forecasted.

22. The system of claim 21, wherein forecasting is performed on a per customer, per product basis and wherein forecasting may be based on at least one of the following models: time series analysis with moving averages, regression analysis, and lifecycle models.

23. The system of claim 20, wherein said demand forecasting component collects customer-level input and makes forecast changes visible in a collaborative environment.

24. The system of claim 23, wherein said demand forecasting component provides reporting of at least one of actual and required inventory levels, actual and required inventory usage, units or dollars, forecasted customer demand, and forecasted industry demand for plant loading.

25. The system of claim 20, wherein said distribution planning component provides multiple views for supply chain planning, wherein said multiple views comprise a statistical view for applying mathematical models, a marketing view that is product family and region focused, a sales view that is customer focused, and a manufacturing view that is used for resource management.

26. The system of claim 20, wherein said order replenishment component replenishes stock levels using forecast results, on hand inventory, WIP inventory, and in transit inventory.
